(19) United States
(12) Patent Application Publication
(10) Pub. No.: US 2021/0017769 A1
(43) Pub. Date: Jan. 21, 2021

(54) SHADING DEVICE HAVING AT LEAST ONE AWNING

(71) Applicant: Plaspack Netze GmbH, Schwanenstadt (AT)

(72) Inventor: Oliver BALAZ, Gmunden (AT)

(21) Appl. No.: 16/492,242

(22) PCT Filed: Mar. 7, 2018
(86) PCT No.: PCT/EP2018/055688

§ 371 Date: Nov. 4, 2019

(30) Foreign Application Priority Data
Mar. 7, 2017 (EP) 17159752.9

(51) Int. Cl. E04F 10/06

(52) U.S. Cl. CPC E04F 10/0648; E04F 10/067

(57) ABSTRACT

A shading device having at least one awning and having at least one winding device, which is provided for winding and unwinding the awning and which has a rigging that is stretched taut along a side or a diagonal of the awning, which rigging is rotationally coupled to the windable and unwindable awning. In order to embody this shading device in a particularly durable fashion, it is proposed for the rigging to be embodied as torsionally rigid or low-torsion and for it to be rotationally coupled to the awning over the entire length of the side or diagonal of the awning.

### FIELD OF THE INVENTION

The invention relates to a shading device having at least one awning and having at least one winding device, which is provided for winding and unwinding the awning and which has a rigging that is stretched taut along a side or a diagonal of the awning, which rigging is rotationally coupled to the windable and unwindable awning.

### BACKGROUND OF THE INVENTION

There are shading devices known from the prior art with winding devices, which are embodied in the form of a roller-furling device for winding and unwinding an awning. To this end, the winding device has a rigging embodied as a steel cable, which is stretched taut along a diagonal of the awning and is rotationally coupled to the awning. By activating a jib furler of the winding device, the rigging is rotated and as a result, the awning is either wound or unwound by the rigging. It is disadvantageous that an awning cannot be wound in a crease-free way with a roller-furling device, which can result in increased mechanical stresses on the awning and damage to it.

There are also known shading devices (EP2216461A2), which are able to wind and unwind an awning in a comparatively crease-free way by means of a rigid winding shaft on a winding device. Such winding devices, however, are comparatively complex from a design standpoint.

### SUMMARY OF THE INVENTION

The object of the invention, therefore, based on the prior art described at the beginning, is to improve the durability of a shading device with a windable and unwindable awning on a rigging. In addition, the shading device should be embodied simply from a design standpoint.

The invention attains the stated object in that the rigging is embodied as torsionally rigid or low-torsion and is rotationally coupled to the awning over the entire length of the side or diagonal of the awning.

If the rigging is embodied as torsionally rigid or low-torsion, then the rigging is able to withstand imparted torques with comparatively little torsion and thus similarly to a rigid winding shaft known from the prior art, can ensure an even winding and unwinding of the awning on the winding device—even in those cases in which the rigging is embodied for relatively wide awnings with a comparatively large span. This danger of creasing can be further reduced if the rigging is rotationally coupled to the awning over the entire length of the side or diagonal of the awning. Such a rotational coupling can specifically prevent a relative movement of the rigging in relation to the awning and thus prevent the awning from twisting over course of the side or diagonal. This ensures a crease-free winding and unwinding of the awning. According to the invention, therefore, with the given design simplicity of the winding device and using a torsionally rigid or low-torsion rigging, a shading device can be produced, which can also have a high durability of the awning. The design according to the invention also makes it possible for the awning to be detached from the shading device and mounted on it in a user-friendly way. It is thus possible, for example, for the awning to be easily and safely stowed over the winter months.

A particularly durable rotational coupling between the rigging and awning can be produced if the rigging is sewn and/or glued to the awning over the entire length of the side or diagonal of the awning. It is thus possible to ensure a durable, crease-free winding and unwinding of the awning.

Another design simplification of the winding device can be enabled if the rigging is embodied as a rope. In addition, such a rigging composed of a plurality of oppositely twisted strands can be particularly torsionally rigid. Preferably, the rope is embodied as a fiber rope in order to withstand high mechanical stresses and thus further increase the durability of the device.

Preferably, the fiber rope has a kernmantle braiding with a polyester braided sheath and an HPPE (high performance polyethylene) braided core—which can ensure a particularly durable rigging.

If the shading device has a belt that extends along the side or diagonal of the awning and is firmly attached to the awning, with the rigging extending between the awning and the belt, then it is possible to produce a compact, flexible shaft, which can be particularly advantageous with regard to the crease-free winding and unwinding of the awning. If the belt is embodied as a webbing, then this makes it possible for it to be durably attached to the awning, even when powerful tensile forces are exerted on the rigging.

The design of the winding device can be further simplified if the rigging is sewn to the belt.

If the belt is sewn to the awning, then not only can they be attached to each other in a simple way, but it is also possible to further increase the durability of the shading device.

### BRIEF DESCRIPTION OF THE DRAWINGS

The subject of the invention is shown in greater detail in the figures byway of example based on an embodiment variant. In the drawings:

FIG. 1 shows atop view of a partially depicted shading device and

FIG. 2 is a sectional view along line I-II in FIG. 1.

### DETAILED DESCRIPTION OF THE PREFERRED EMBODIMENTS

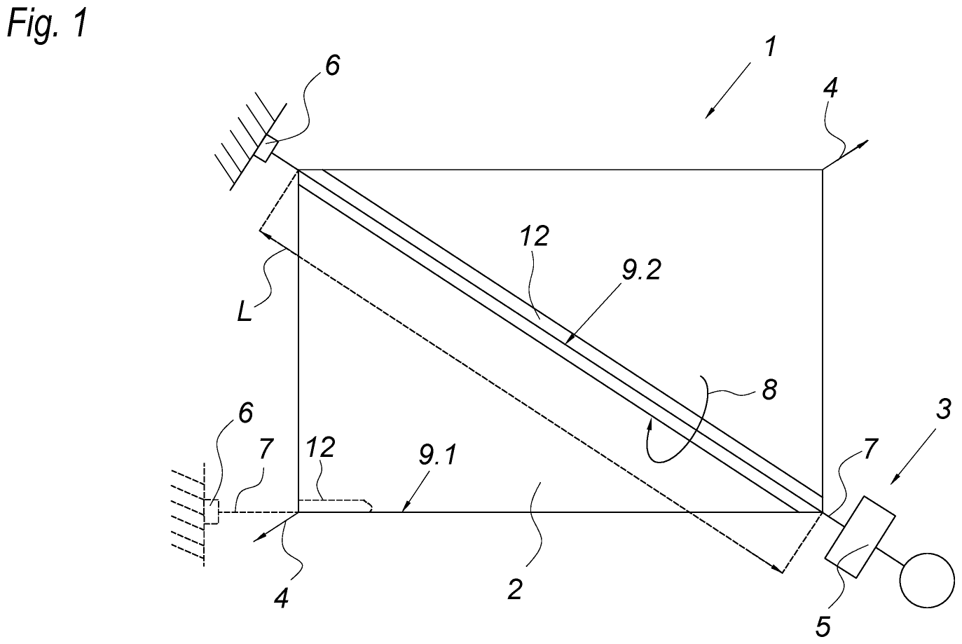

FIG. 1 shows an example of a shading device 1 with an essentially four-sided awning 2 and a winding device 3. The winding device 3 is used for winding and unwinding the awning 2, which can be stretched taut by means of tensioning ropes 4, which are attached to opposite corners of the awning 2 and are part of a tensioning device that is not shown in detail. In the exemplary embodiment, the winding device 3 is embodied in the form of a roller-furling device and for this purpose, has a jib furler 5 and a halyard swivel 6 between which a rigging 7 is stretched taut, which can be acted on in a rotation direction 8 by means of the jib furler 5. Since the rigging 7 that is stretched taut along a diagonal 9.2 of the awning 2 is rotationally coupled to the awning 2, the awning 2 can be rolled up or unrolled depending on the rotation direction 8 of the opposing rotation directions of the winding device 3.

According to the invention, the rigging 7 is embodied as torsionally rigid or low-torsion and therefore has no torsion or hardly any and has a high torsional rigidity in the rotation directions 8—which prevents the awning 2 from twisting relative to the rigging 7.

In general, it should be noted that such a rigging 7 can be a fiber rope with a kemmantle braiding in order to thus ensure the high torsional rigidity. For example, fiber ropes of this kind are used as a luff line for a head sail, gennaker, etc. Preferably, such a torsionally rigid or low-torsion fiber rope with a kernmantle braiding can, for example, have a polyester braided sheath and an HPPE (high performance polyethylene) braided core.

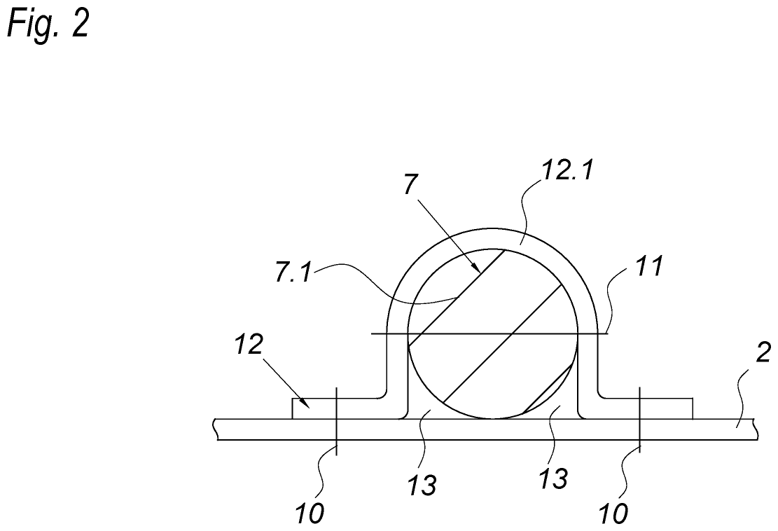

In addition, the awning 2 is rotationally coupled over the entire diagonal 9.2 of the awning 2—as is clearly indicated in FIG. 2 by the fact that the rigging 7 is indirectly attached to the awning 2 by means of indicated seams 10, 11. This is indirect in that a belt 12, which is sewn to the awning 2 by means of seams 10, is sewn to the rigging 7 by means of seams 11.

FIG. 1 also shows with dashed lines that the rigging 7 can also be provided extending along a side 9.1 of the awning 2. Apart from the lateral dimension, this embodiment variant is designed identically to one with the diagonal span. Here, too, the rigging 7 is rotationally coupled to the awning 2 over the entire length L of the side 9.1 of the awning 2—which makes it possible to achieve a particularly durable rotational coupling between the rigging and awning.

This belt 12 embodied as a webbing 12.1 extends along the same diagonal 9.2 as the rigging 7 so that the rigging 7 can be enclosed between the belt 12 and the awning 2. This protects the rigging 7 on the one hand—and can also achieve a particularly rugged rotational coupling of the rigging 7 to the awning 2.

A gap between the rigging 7, the awning 2, and the belt 12 can be filled with adhesive 13 in order to thus increase the durability of the flexible winding shaft with a rigging 7.

1. A shading device comprising:
at least one awning;
at least one winding device, which is provided for winding and unwinding the awning; and
a rigging that is stretched taut along a side or a diagonal of the awning, which rigging is rotationally coupled to the windable and unwindable awning, wherein the rigging is torsionally rigid or low-torsion and is rotationally coupled to the awning over a entire length of the side or diagonal of the awning.

2. The shading device according to claim 1, wherein the rigging is sewn and/or glued to the awning over the entire length of the side or over the entire length of the diagonal of the awning.

3. The shading device according to claim 1, wherein the rigging is a fiber rope.

4. The shading device according to claim 3, wherein the fiber rope has a kernmantle braiding with a polyester braided sheath and an HPPE (high performance polyethylene) braided core.

5. The shading device according to claim 1, wherein the shading device has a belt which extends along the side or diagonal of the awning and is firmly attached to the awning, with the rigging extending between the awning and the belt.

6. The shading device according to claim 5, wherein the rigging is sewn to the belt.

7. The shading device according to claim 5, wherein the belt is sewn to the awning.

8. The shading device according to claim 5, wherein the belt is a webbing.
